(19) United States
(12) Patent Application Publication
(10) Pub. No.: US 2023/0176619 A1
(43) Pub. Date: Jun. 8, 2023

(54) DISPLAY DEVICES WITH PIVOT CONNECTIONS

(71) Applicant: Hewlett-Packard Development Company, L.P., Spring, TX (US)

(72) Inventors: Mark David Senatori, Spring, TX (US); Dong Ryul Cha, Spring, TX (US); Cheng Chi Cheng, Taipei City (TW)

(73) Assignee: Hewlett-Packard Development Company, L.P., Spring, TX (US)

(21) Appl. No.: 17/997,029

(22) PCT Filed: Apr. 30, 2020
(86) PCT No.: PCT/US2020/030670

§ 371 Date: Oct. 25, 2022

(51) Int. Cl. G06F 1/16

(52) U.S. Cl. CPC G06F 1/165; G06F 1/1624; G06F 1/1681

(57) ABSTRACT

An example computing device includes a body and a first display device including a lower end that is pivotably connected to the body and a front surface including a first display area. The computing device further includes a second display device including a pivotable end that is pivotably connected to the body and a free end opposite the pivotable end. The computing device further includes a bias member connecting the second display device to the first display device. The bias member resiliently urges the free end of the second display device towards the front surface of the first display device.

### BACKGROUND

Computing device may include multiple display devices to provide increased display area. A desktop computer may have multiple connected external monitors. A notebook computer may include multiple integral display panels that may be actuated to provide the opening and closing functionality of the notebook computer.

### BRIEF DESCRIPTION OF THE DRAWINGS

FIG. 1A is a perspective view of an example computing device including display devices with sliding and pivot connections, where the computing device is shown closed.

FIG. 1B is a perspective view of the example computing device of FIG. 1A shown partially closed.

FIG. 1C is a perspective view of the example computing device of FIG. 1A shown partially opened.

FIG. 1D is a perspective view of the example computing device of FIG. 1A shown opened.

FIG. 2A is a perspective view of the example computing device of FIG. 1A shown with hinges and closed.

FIG. 2B is a perspective view of the example computing device of FIG. 1A shown with hinges and partially closed.

FIG. 2C is a perspective view of the example computing device of FIG. 1A shown with hinges and partially opened.

FIG. 2D is a perspective view of the example computing device of FIG. 1A shown with hinges and opened.

FIG. 3A is a side view of the example computing device of FIG. 1A shown closed.

FIG. 3B is a side view of the example computing device of FIG. 1A shown partially closed.

FIG. 3C is a side view of the example computing device of FIG. 1A shown partially opened.

FIG. 3D is a side view of the example computing device of FIG. 1A shown opened.

FIG. 4A is a partial side view of the example computing device of FIG. 1A shown partially closed.

FIG. 4B is a partial side view of the example computing device of FIG. 1A shown partially opened.

FIG. 4C is a partial side view of the example computing device of FIG. 1A shown opened.

FIG. 5 is a perspective view of an example hinge mechanism to provide sliding and pivot connections to display devices of a computing device with a slider in a channel.

FIG. 6 is a perspective view of an example hinge mechanism to provide sliding and pivot connections to display devices of a computing device with a slider on a rail.

FIG. 7 is a rear perspective view of the example computing device of FIG. 1A.

### DETAILED DESCRIPTION

Computing devices with multiple display devices often provide discontinuous active display areas. This may create an interrupted display space for which a user may have to mentally compensate, for example, when moving a cursor from one display device to another display device. In addition, a gap between display devices may be aesthetically displeasing and may waste space, in that the display devices occupy more space than their combined active display areas.

A computing device, such as a notebook computer, includes multiple display devices connecting by a sliding pivot. A main display device is located at the rear of the computing device and rotates open. An auxiliary display device is positioned forward, between the body of the computing device and the main display device, and is raised as the main display device is opened.

A bias element, such as a spring-loaded link arm, connects the display devices to constrain their mutual motion. As the main display device is opened, the bias element lifts the auxiliary display device and keeps the auxiliary display device adjacent or in contact with the main display device. The display areas of the main and auxiliary display devices are kept close together and appear as a nearly continuous display. The display devices provide increased display area with reduced or eliminated gap therebetween.

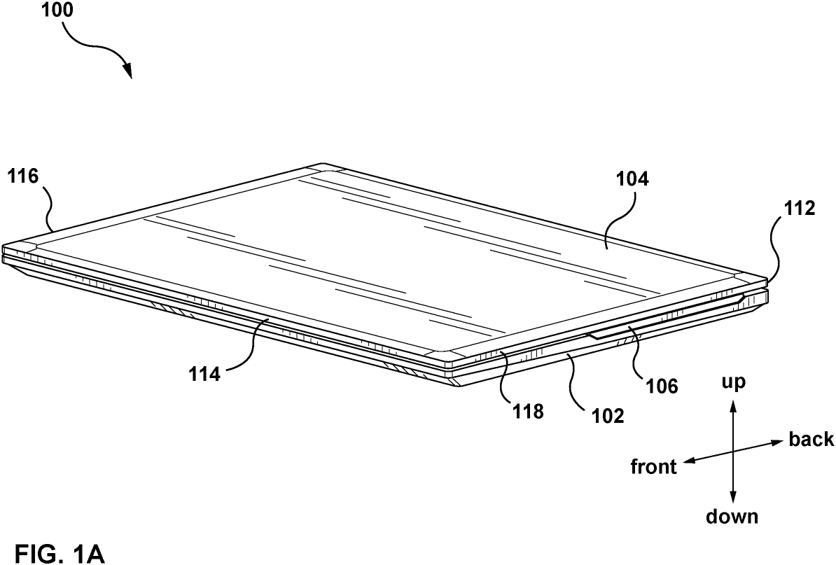

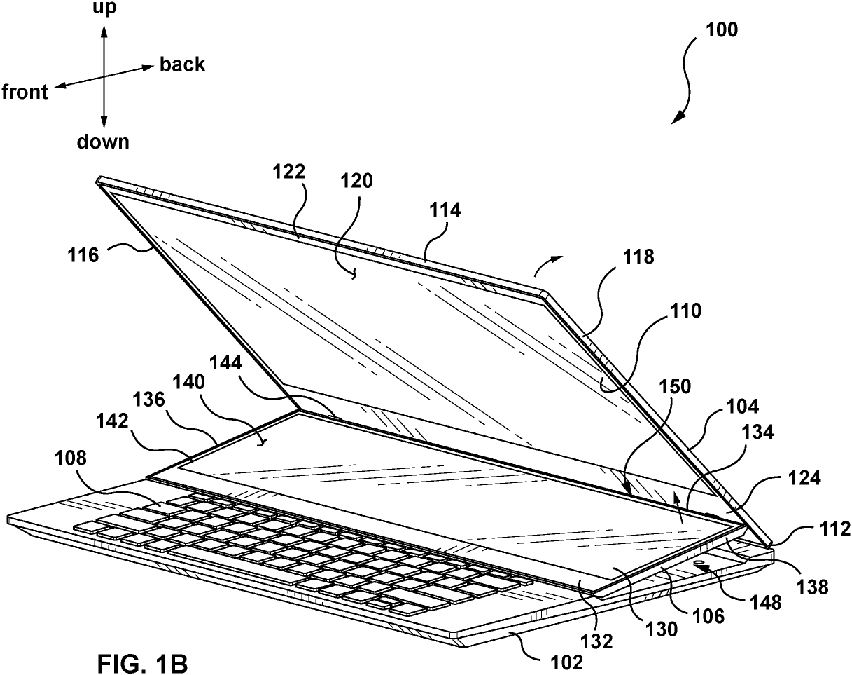

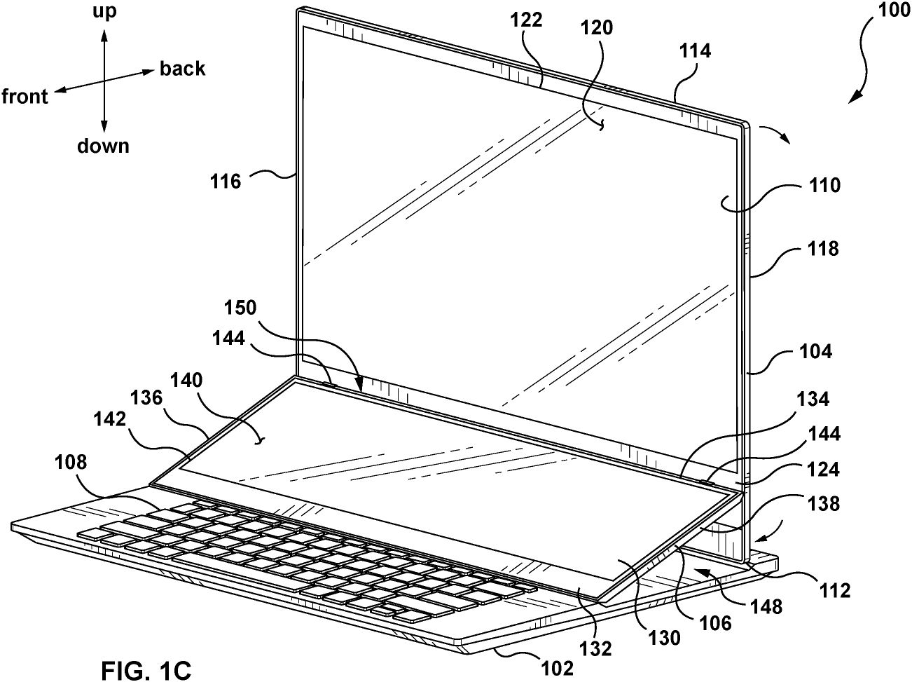

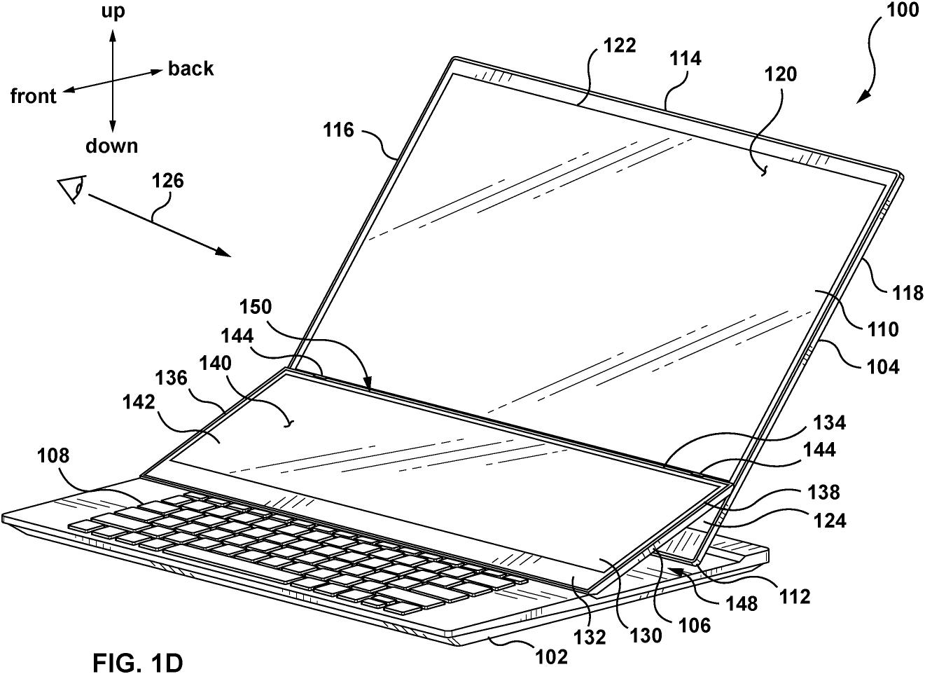

FIGS. 1A to 1D show an example computing device 100. The computing device 100 is portable and may be referred to as a notebook or laptop computer.

The computing device 100 includes a body 102, a first display device 104, and a second display device 106. The second display device 106 is positioned forward of the first display device 104.

The body 102 may include a keyboard 108, trackpad, touchpad, or similar input device. The body 102 may further include various connector receptacles, such as a serial port, a network port, a power port, a headphone jack, and so on. The body 102 is shaped to support the computing device 100 on a surface, such as a table, tray, or a user’s lap.

The first or main display device 104 includes a flat display panel 110, such as a liquid-crystal display (LCD) panel, light-emitting diode (LED) display panel, organic LED (OLED) display panel, or similar.

The first display device 104 includes a lower end 112, an upper end 114, opposing sides 116, 118, and a front surface 120 that contains a first active display area 122. The lower end 112 is connected to the body 102. The upper end 114 is opposite the lower end 112 and is free, as are the opposing sides 116, 118.

The term “end” is used herein to denote a location at or near an outer edge or outer boundary of a component.

The first active display area 122 may be smaller than the front surface 120. In this example, a non-display area 124 is located below the active display area 122. The front surface 120 may be physically continuous over the discontinuity between the active display area 122 and the non-display area 124. For example, the first display device 104 may include a continuous sheet of glass or similar material to provide a smooth surface for the active display area 122 and the non-display area 124.

The lower end 112 of the first display device 104 is slidably and pivotably connected to the body 102. The first display device 104 may thus rotate open and closed with respect to the body 102 as its lower end 112 simultaneously slides with respect to the body 102. The first display device 104 is moveable between a closed position (FIG. 1A), in which the front surface 120 faces the keyboard 108 or other input device at the body 102, and an opened position (FIG. 1D) in which the front surface 120 and the keyboard 108 are exposed to the user’s line of sight 126 and ready to be used. The first display device 104 has one rotational degree of freedom (pivot open/closed) and one translational degree of freedom (move forward/back).

The second or auxiliary display device 106 includes a flat display panel 130, such as an LCD display panel, LED display panel, OLED display panel, or similar. The second display device 106 may have a smaller display area than the first display device 104. In the example illustrated, the second display device 106 has about the same width as the first display device 104 and has as shorter height.

The second display device 106 includes a lower pivotable end 132, an upper free end 134, opposing sides 136, 138, and a front surface 120 that contains a second active display area 142. The lower pivotable end 132 is pivotably connected to the body 102. The upper free end 134 is opposite the lower pivotable end 132 and is constrained to move relative to the first display device 104. The opposing sides 136, 138 are free.

The pivotable end 132 of the second display device 106 may be positioned adjacent the keyboard 108 or other input device at the body 102. The pivotable end 132 is pivot connected to the body 102 by a hinge or similar mechanism. The second display device 106 may thus be rotated to rise from the body 102 by pivoting at the pivotable end 132 and lifting from the body 102 at the free end 134. The rising rotation of the second display device 106 brings the auxiliary active display area 142 into closer alignment with the user’s line of sight 126. The second display device 106 is thus moveable between a closed position (FIG. 1A), in which the second display device lies flat against the body 102 and faces the first display device 104, and an opened position (FIG. 1D) in which the active display area 142 is rotated towards to the user’s line of sight 126. The second display device 106 has one rotational degree of freedom (pivot open/closed) and no translational degrees of freedom.

The body 102 may include a depression or cutout 148 to receive the second display device 106 in the closed position. The second display device 106, when received in the cutout 148, fits flush with the body 102 to accommodate closure of the first display device 104.

The free end 134 of the second display device 106 is urged towards the front surface 120 of the first display device 104, as will be discussed in greater detail below. The free end 134 may contact or nearly contact the front surface 120 of the first display device 104 in the opened position (FIG. 1D), so that a small or negligible gap 150 exists between the first and second display devices 104, 106. The reduced or eliminated gap 150 may allow the user to perceive the first and second display devices 104, 106 as continuous or nearly continuous. This may allow for the of display images and graphics in a continuous manner, such that visual flow is uninterrupted. The contact or near contact or the free end 134 against the front surface 120 of the first display device 104 may occur in positions closer to the closed position (FIG. 1A), as shown in FIGS. 1B and 1C.

The front surface 120 of the first display device 104 may be continuous over a range of sliding of the free end 134 of the second display device 106 against the front surface 120. To reduce sliding resistance while still allowing contact, the second display device 106 may include a friction-reducing material at the free end 134. A friction-reducing strip 144 may be applied to the free end 134 for sliding contact with the front surface 120. An example suitable friction-reducing material is polyoxymethylene, which may also be known as acetal and polyacetal.

The computing device 100 further includes a member that connects the second display device 106 to the first display device 104 to urge the free end 134 of the second display device 106 to slide relative to the front surface 120 of the first display device 104. The member may resiliently bias the free end 134 into contact with the front surface 120. The member may be included in a hinge mechanism that connects the display devices 104, 106.

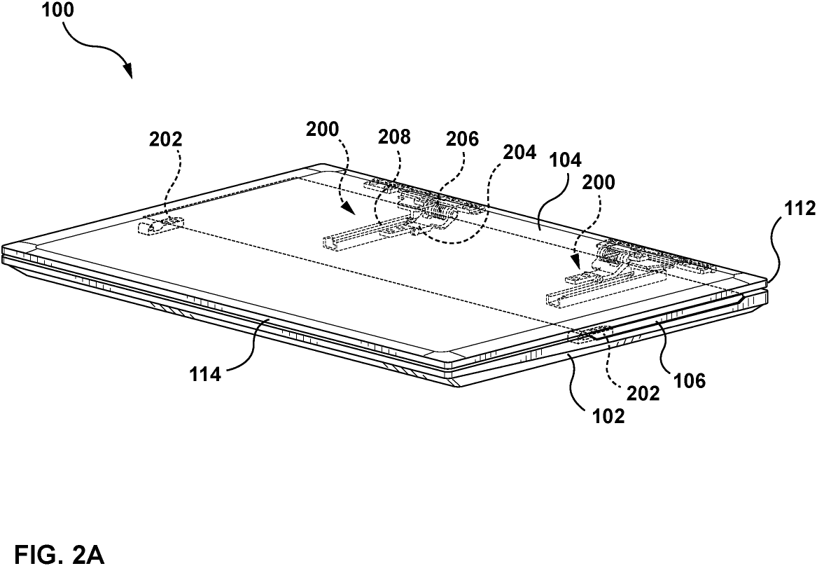

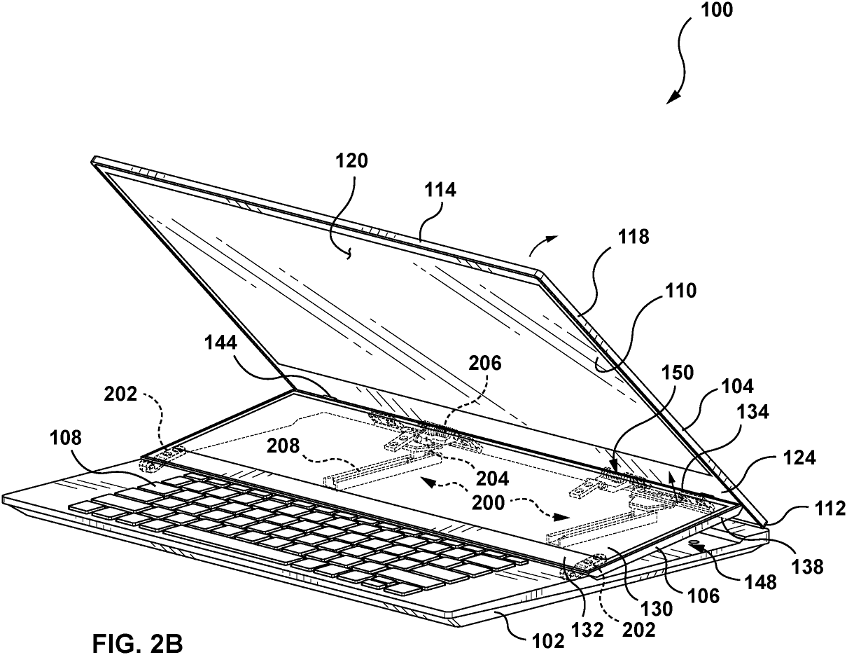

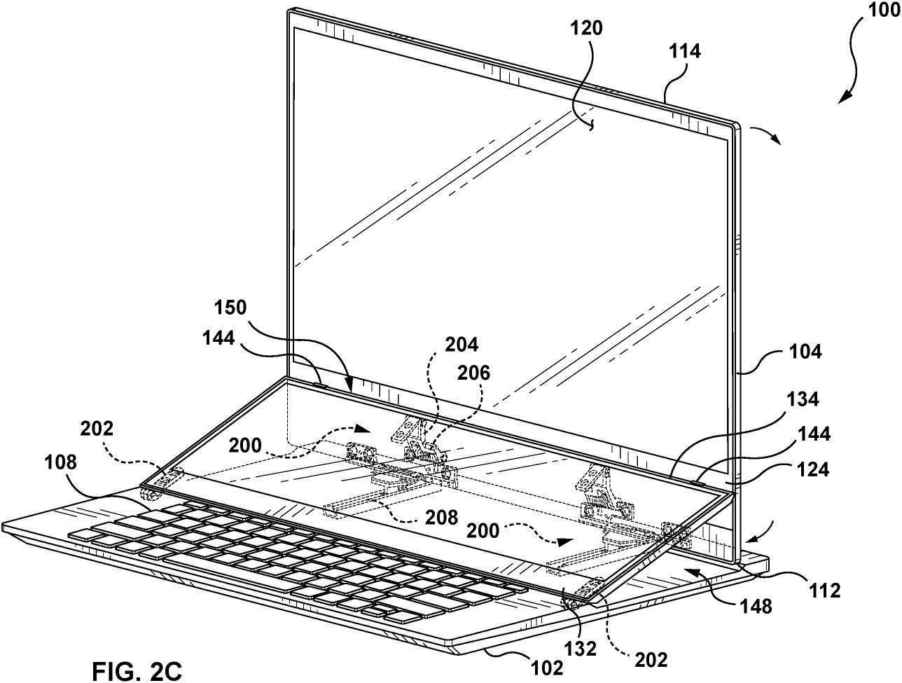

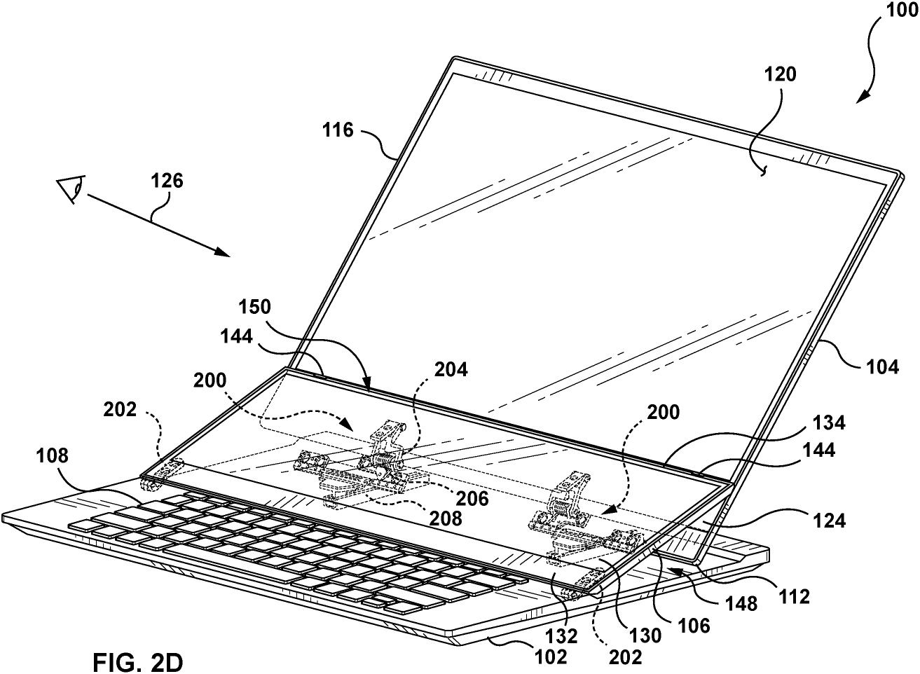

As shown in FIGS. 2A to 2D, a hinge mechanism 200 may include a member, such as a link arm 204, that connects the second display device 106 to the first display device 104 to constrain the second display device 106 to pivotably rise from the body 102 as the lower end 112 of the main display device 104 is rotated and slid when the first display device 104 is opened.

The hinge mechanism 200 may further include a resilient member 206, such as a spring, to bias the link arm 204. A channel 208 may be provided to the mechanism 200 to allow a slider to move the lower end 112 of the first display device 104 forward and backward. The channel 208 may be affixed to the body 102.

A forward hinge 202 may be provided to the lower pivotable end 132 of the second display device 106 to pivotably connect the second display device 106 to the body 102.

Any suitable number of rear hinge mechanisms 200 and forward hinges 202 may be used. In this example, two of each are used.

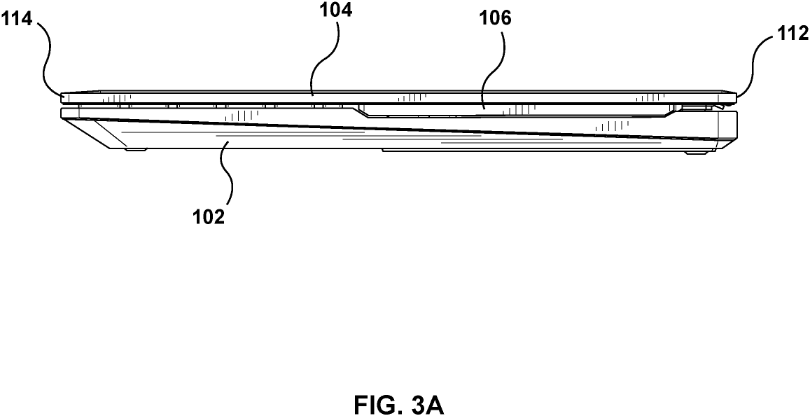

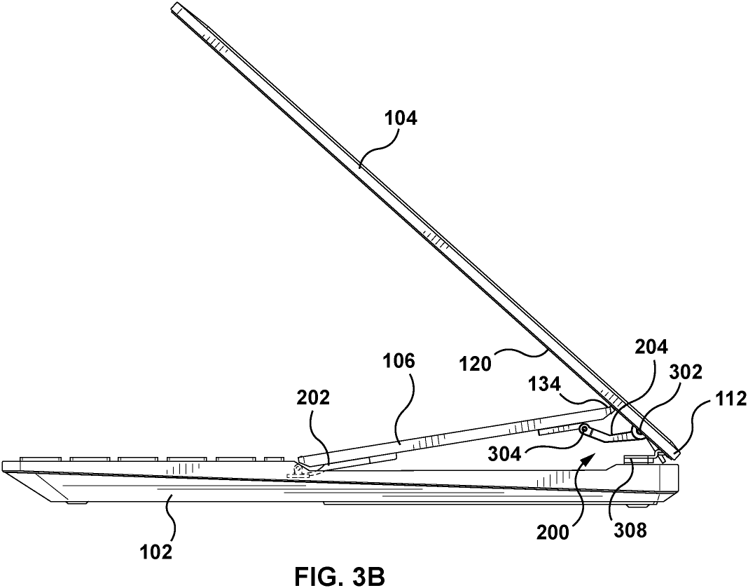

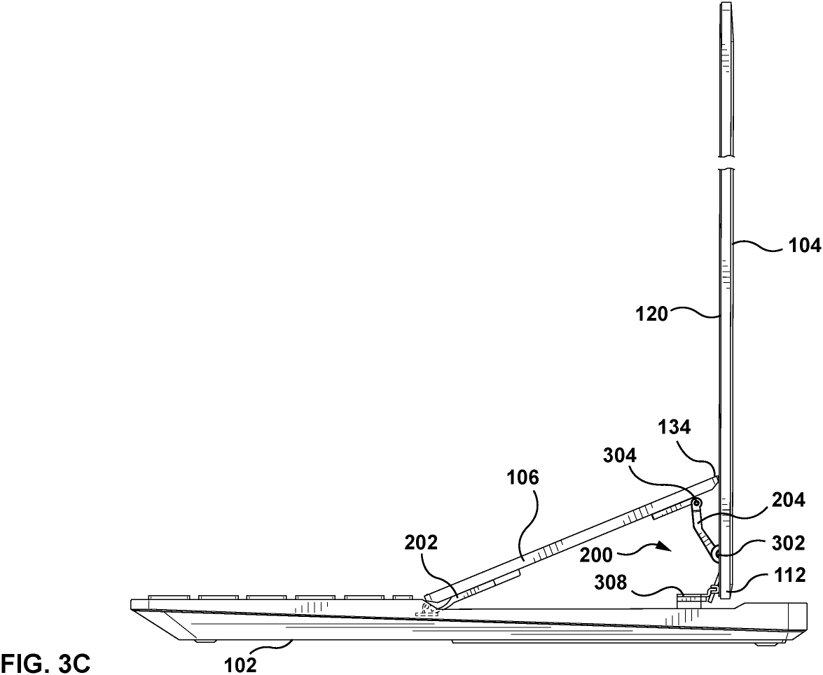

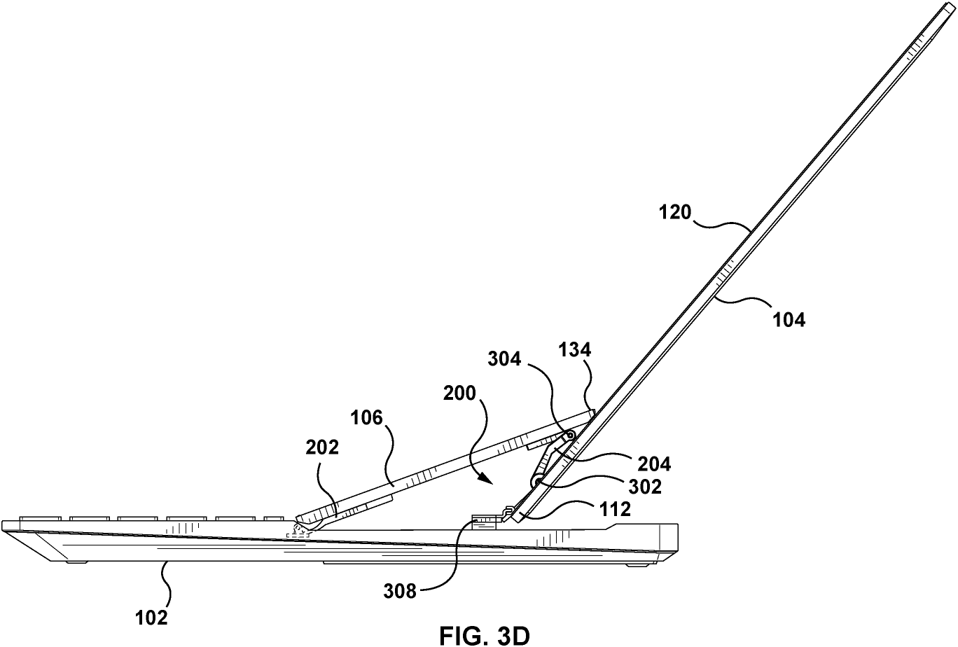

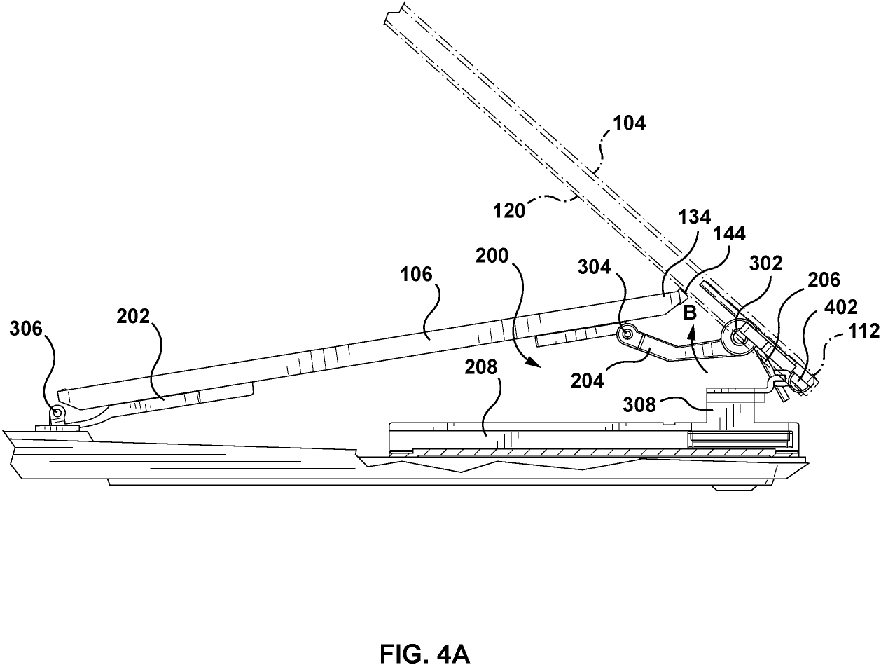

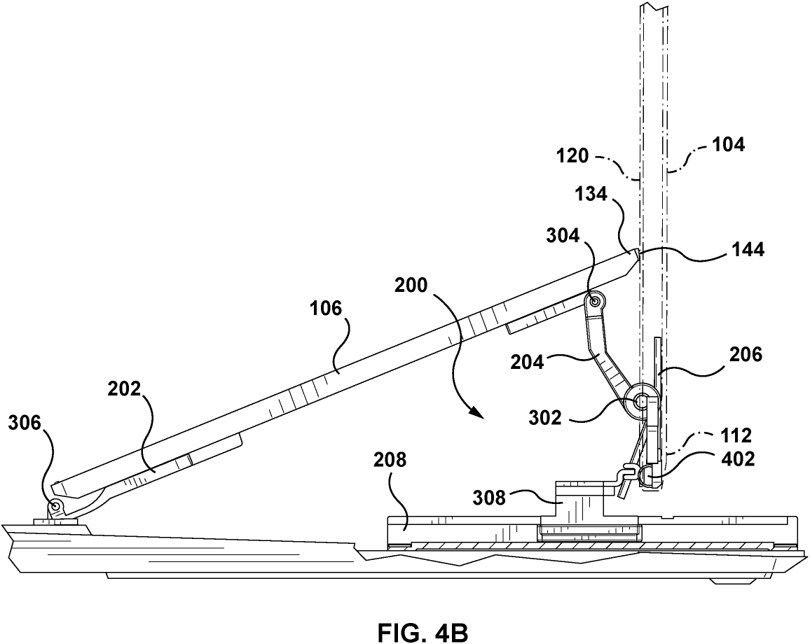

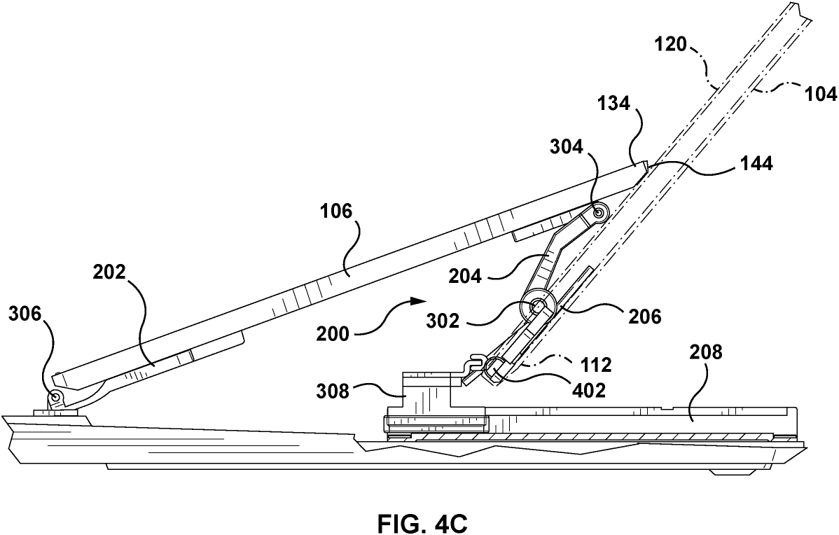

With reference to FIGS. 3A to 3D and 4A to 4C, the link arm 204 may include a first end with a pivot connection 302 to the first display device 104 and a second end with a pivot connection 304 to the second display device 106.

The link arm 204 may be a biased by the resilient member 206 to urge the free end 134 of the second display device 106 towards the front surface 120 of the first display device 104. Biasing may be sufficiently strong such that the free end 134 of the second display device 106 is urged into contact with the front surface 120 of the first display device 104.

The resilient member 206 couples the link arm 204 to the first display device 104 and exerts a biasing moment that urges the link arm 204 to rotate about the pivot connection 302 at the first display device 104 in a direction B (clockwise in FIG. 4A) that tends to lift the second display device 106. Example resilient members include torsion springs, extension/compression springs, and torsion rods.

The lower end 112 of the first display device 104 may be pivot connected to a slider 308 that rides in the channel 208 that is affixed to or formed in the body 102. The pivot connection may include a hinge 402, such as a friction hinge that provides resistance sufficient to allow a chosen orientation of the first display device 104 to be held without application of external force.

The slider 308 may be constrained to slide within the channel 208 over a range of linear motion. In other examples, the slider 308 may ride on a rail that is attached to the body 102. The rail may include a pair of cylindrical rods.

The forward hinge 202 may include a bracket attached to the second display device 106 and a pivot point 306 attached to the body 102 of the computing device.

In operation, a user manually lifts to the first display device 104 from the closed position towards the opened position. As the first display device 104 is rotated about the hinge 402 connected with the slider 308 at the lower end 112, the slider 308 slides in the channel 208 towards the front of the computing device 100. The lifting movement experienced by the pivot connection 302 of the link arm 204 to the first display device 104 causes the link arm 204 to pull the second display device 106 upwards by virtue of the pivot connection 304 of the link arm 204 to the second display device 106. The link arm 204 raise the free end 134 of the second display device 106 from the body 102. During this motion, the spring 206 or other bias element coupled to the link arm 204 urges the free end 134 of the second display device 106 towards the front surface 120 of the first display device 104. The free end 134 may contact and slide against the front surface 120 up to a position adjacent the active display area 122 of the first display device 104, at which point the computing device 100 is fully opened. Closing the computing device 100 is an opposite process in that the user manually rotates the first display device 104 towards the closed position and the second display device 106 is lowered by the link arm 204 into its closed position.

In their respective opened positions, the first display device 104 and the second display device 106 are oriented at different angles with respect to the body 102 of the computing device 100. The second display device 106 is oriented at a shallower angle than the first display device 104. At the same time, the second display device 106 is adjacent, and may abut, the first display device 104 to provide a nearly continuous compound display area formed from active display areas 122, 142. Total display area may be larger than comparable computing devices of the same overall size.

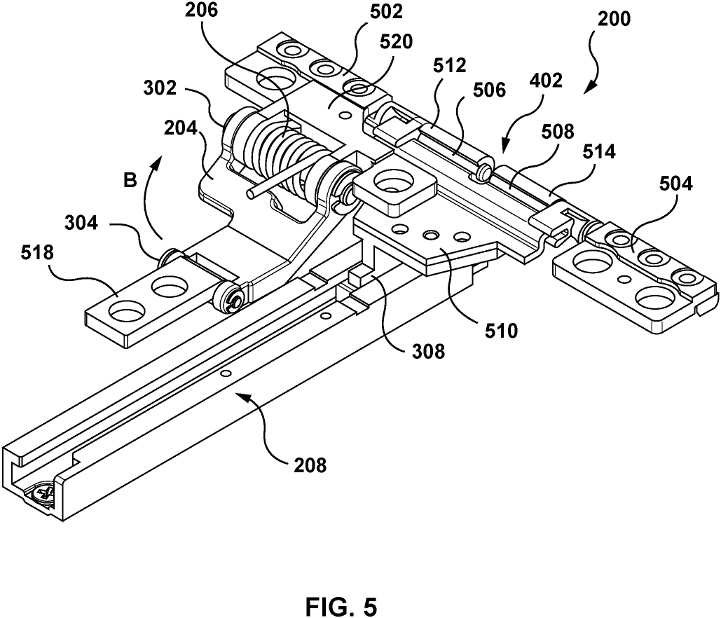

FIG. 5 shows an example slidable hinge mechanism 200 that includes a spring-loaded arm and slider arrangement to provide a rotating and sliding motion to a main display device and a raising motion to an auxiliary display device.

The mechanism 200 includes main display device mounting brackets 502, 504, a main hinge 402, a slider 308, a hinge plate 510, a slider channel 208, a link arm 204, a spring 206, and an auxiliary display device mounting bracket 518.

The main display device mounting brackets 502, 504 may be secured to a main display device 104 by screws or other fasteners to move in unison with the main display device 104. Any number of brackets 502, 504 may be provided, such as a first bracket 502 and a second bracket 504 at opposite ends of the main hinge 402. The first bracket 502 may include a leg 520 extending therefrom to provide a pivot connection 302 with the link arm 204.

The main hinge 402 is formed from the main display device mounting brackets 502, 504 and the hinge plate 510. Pins 506, 508 may extend from the first and second brackets 502, 504 to pivotably mate with sleeves 512, 514 at the hinge plate 510.

The hinge plate 510 is affixed to the slider 308. The hinge plate 510 slides with the slider 308 and provides a base for rotation of the main display device mounting brackets 502, 504 and attached main display device 104.

The slider channel 208 captures the slider 308 and limits movement of the slider 308 to linear forward and backward movement. The slider channel 208 may be defined by an assembly that is attached to a body 102 of a computing device 100.

The link arm 204 includes a first pivot connection 302 (e.g., pin and sleeve) with the leg 520 of the main display device mounting bracket 502 and a second pivot connection 304 (e.g., pin and sleeve) with the auxiliary display device mounting bracket 518, to which an auxiliary display device 106 is affixed with screws or other fasteners.

The spring 206 in this example is a torsion spring that is coaxial with the first pivot connection 302. The spring 206 may surround a pin that defines this pivot connection 302. The spring 206 provides a bias moment to the link arm 204 that urges the link arm 204 to rotate about the pivot connection 302 in a direction B that raises the second pivot connection 304 from the body 102 of the computing device 100. In this example, the spring 206 is braced against the leg 520 of the main display device mounting bracket 502 to cause rotation of the link arm 204 relative to the main display device mounting bracket 502.

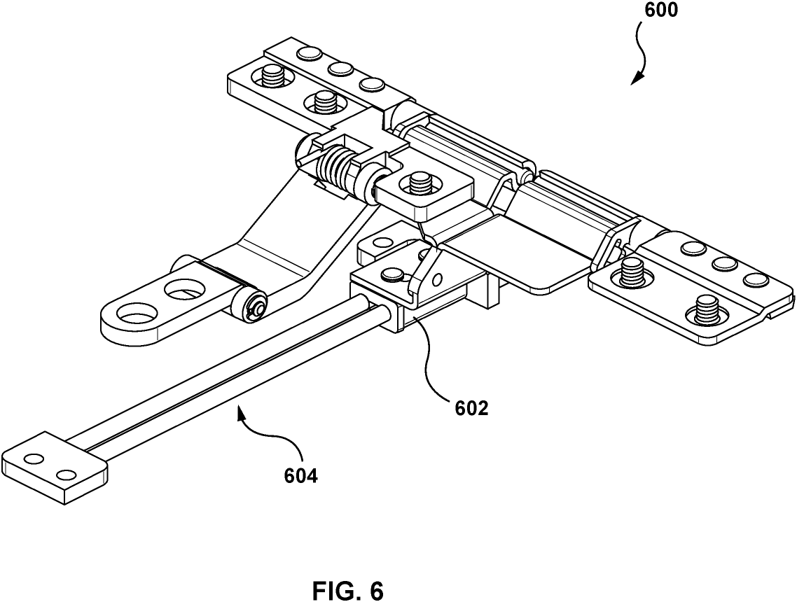

FIG. 6 shows an example slidable hinge mechanism 600 that includes a spring-loaded arm and slider arrangement to provide a rotating and sliding motion to a main display device and a raising motion to an auxiliary display device. The mechanism 600 includes components described with respect to the mechanism 200 and such detail will not be repeated here.

A slider 602 is positioned on a pair of rails 604 that are attached to a body 102 of a computing device 100. The rails 604 may be cylindrical rods and the slider 602 may include bores sized to fit the rails 604. The rails 604 may limit movement of the slider 602 to linear forward and backward movement.

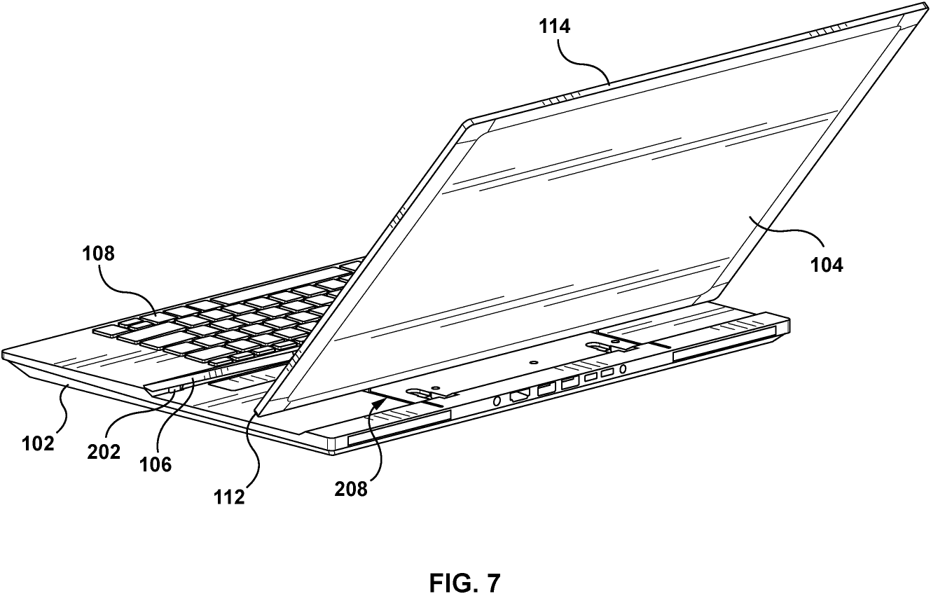

As shown in FIG. 7, the hinge mechanism discussed above is generally contained between the display devices 104, 106, to provide aesthetic appeal to the computing device 100. A channel 208 (or rod) may be exposed when viewed from behind.

In view of the above, it should be apparent that display areas of main and auxiliary display devices of a portable computing device may be maintained in close proximity and may present a nearly continuous compound display. A bias member, such as a spring-loaded mechanism, constrains the mutual motion of the display devices to provide increase display area with reduced or eliminated gap therebetween when the portable computing device is opened. A compact arrangement is provided when the portable computing device is closed.

It should be recognized that features and aspects of the various examples provided above can be combined into further examples that also fall within the scope of the present disclosure. In addition, the figures are not to scale and may have size and shape exaggerated for illustrative purposes.

1. A computing device comprising:
a body;
a first display device including:
a lower end that is pivotably connected to the body; and
a front surface including a first display area;
a second display device including:
a pivotable end that is pivotably connected to the body; and
a free end opposite the pivotable end;
a bias member connecting the second display device to the first display device, the bias member to resiliently urge the free end of the second display device towards the front surface of the first display device.

2. The computing device of claim 1, wherein the bias member is to resiliently urge the free end of the second display device into contact with the front surface of the first display device.

3. The computing device of claim 1, wherein the first display device is moveable between:
a closed position in which the front surface faces a keyboard at the body; and
an opened position in which the front surface and the keyboard are exposed.

4. The computing device of claim 3, wherein, as the first display device is moved from the closed position to the opened position, the bias member is to raise the free end of the second display device from the body.

5. The computing device of claim 3, wherein, as the first display device is moved from the closed position to the opened position, the bias member is to slide the free end against the front surface of the first display device up to a position adjacent an active display area of the first display device.

6. The computing device of claim 5, wherein the second display device includes a friction-reducing material at the free end.

7. The computing device of claim 5, wherein the front surface of the first display device is continuous over a range of sliding of the free end of the second display device against the front surface.

8. The computing device of claim 1, wherein the bias member includes:
a spring-loaded arm pivotably connected to the first display device and pivotably connected to the second display device.

9. A computing device comprising:
a body;
a main display device including:
a lower end that is slidably and pivotably connected to the body; and
a front surface including a main display area;
an auxiliary display device including:
a pivotable end that is pivotably connected to the body; and
a free end opposite the pivotable end;
a link arm that connects the auxiliary display device to the main display device to constrain the auxiliary display device to pivotably rise from the body as the lower end of the main display device is rotated and slid to rotate the main display device away from the body to expose the main display area.

10. The computing device of claim 9, further comprising a slider that slidably and pivotably connects the lower end of the main display device to the body.

11. The computing device of claim 9, further comprising a spring coupled to the link arm, the spring to bias the free end of the auxiliary display device into contact with the main display area.

12. The computing device of claim 11, wherein the spring comprises a torsion spring.

13. A computing device comprising:
a body;
a first display device;
a second display device pivotably connected to the body of the computing device;
a slider to slidably and pivotably connect the first display device to the body;
an arm including:
a first end to pivotably connect to the first display device; and
a second end to pivotably connect to the second display device.

14. The computing device of claim 13, further comprising a resilient member coupled to the arm to bias the arm towards an orientation that brings a free end of the second display device into contact with the first display device.

15. The computing device of claim 13, wherein the slider fits into a channel in the body.
